(19) United States
(12) Patent Application Publication
(10) Pub. No.: US 2025/0201459 A1
(43) Pub. Date: Jun. 19, 2025

(54) ELECTRONIC DEVICE SIGNAL INPUT APPARATUS

(71) Applicant: I-STAR ELECTRONICS CO LTD, Shenzhen (CN)

(72) Inventor: Xing TU, Shenzhen (CN)

(21) Appl. No.: 18/419,419

(22) Filed: Jan. 22, 2024

(30) Foreign Application Priority Data
Dec. 19, 2023 (CN) 2023117463353

(51) Int. Cl. H01F 7/02

(52) U.S. Cl. CPC H01F 7/02

(57) ABSTRACT

The present invention discloses an electronic device signal input apparatus, including a housing provided with an operating component, where a first magnet is fixed at an inner end of the operating component, a second magnet is fixed on the housing at a position opposite the first magnet, and the first magnet and the second magnet attract or repel each other.

### TECHNICAL FIELD

The present invention relates to signal input apparatuses, and in particular, to an electronic device signal input apparatus.

### BACKGROUND

At present, an existing gamepad signal input apparatus mainly includes a joystick potentiometer, a rotary potentiometer, and a button. These signal input apparatuses rely on a spring to return to the original position. For example, a structure for returning a gamepad joystick to the original structure disclosed by the Chinese patent announcement No. CN 220176018 U and entitled “GAMEPAD JOYSTICK APPARATUS AND GAMEPAD” is realized by a return spring. A spring is a common mechanical element widely used in various fields. However, long-term or frequent use often leads to spring fatigue, resulting in reduced spring performance and shortened life, affecting the effectiveness of a spring apparatus, and even causing spring failure.

In addition, most existing gamepad signal input apparatuses are still unable to adjust hand resistance of an operating component (a joystick, a rotating shaft, or a lifting slider of a button), resulting in poor hand feel. Although there are currently some prior technologies for improving hand resistance, they either still use springs that are prone to mechanical fatigue, or the structural design is too complex. For example, a joystick feedback apparatus for improving hand feel disclosed by the Chinese patent for invention announcement No. CN 114470740 A and entitled “GAMEPAD AND JOYSTICK FEEDBACK APPARATUS THEREFOR” not only has a complex structural design and is difficult to assemble, but also still uses spring components that are prone to mechanical fatigue. Another example is a joystick feedback force apparatus for improving hand feel disclosed by the Chinese patent for invention announcement No. CN 111318011 B and entitled “GAMEPAD AND JOYSTICK FEEDBACK FORCE APPARATUS THEREFOR”. The structural design is extremely complex, and there are many accessories, leading to high costs, difficulty in maintenance, and a short service life. Therefore, it has become an urgent problem for those skilled in the art to develop an electronic device signal input apparatus that does not rely on a spring component for returning and that can realize a hand resistance adjustment function.

### SUMMARY

In order to solve the above-mentioned disadvantages, the present invention provides an electronic device signal input apparatus.

The above-mentioned objective of the present invention is achieved by means of the following technical solution: An electronic device signal input apparatus includes a housing provided with an operating component, where a first magnet is fixed at an inner end of the operating component, a second magnet is fixed on the housing at a position opposite the first magnet, and the first magnet and the second magnet attract each other.

Further, the operating component is provided with an adjustable telescopic rod that runs through both inner and outer ends of the operating component, and the first magnet is fixed at an inner end of the adjustable telescopic rod.

Further, the adjustable telescopic rod is a threaded rod, and the operating component is provided with an internally threaded through hole that matches the threaded rod for telescopic adjustment.

Further, the adjustable telescopic rod is a polished rod provided with a number of adjustment positioning slots or adjustment positioning holes, and the operating component is provided with a polished hole that matches the polished rod for telescopic adjustment.

Further, the signal input apparatus is a joystick potentiometer, and the operating component is a joystick of the joystick potentiometer.

Further, the signal input apparatus is a rotary potentiometer, and the operating component is a rotating shaft of the rotary potentiometer.

The above-mentioned objective of the present invention is achieved by means of the following another technical solution: An electronic device signal input apparatus includes a housing provided with an operating component, where a first magnet is fixed at an inner end of the operating component, a second magnet is fixed on the housing at a position opposite the first magnet, and the first magnet and the second magnet repel each other.

Further, the signal input apparatus is a button, and the operating component is a lifting slider of the button.

Advantages of the present invention compared with the prior art are as follows: The present invention avoids the use of a spring component, and therefore the service life of a product is not affected due to mechanical fatigue of the spring. Moreover, the present invention has simple structural design, low costs, and is not easily damaged. In addition, hand resistance can be adjusted by adjusting a distance between the magnets, making it easy to adapt to individual needs of different users for hand resistance.

### BRIEF DESCRIPTION OF THE DRAWINGS

FIG. 1 is a schematic diagram of an internal structure of a first embodiment according to the present invention;

FIG. 2 is a schematic diagram of an exterior structure of the first embodiment according to the present invention;

FIG. 3 is a schematic diagram of an internal structure of a second embodiment according to the present invention;

FIG. 4 is a schematic diagram of an exterior structure of the second embodiment according to the present invention;

FIG. 5 is a schematic diagram of an internal structure of a third embodiment according to the present invention;

FIG. 6 is a schematic diagram of an exterior structure of the third embodiment according to the present invention;

FIG. 7 is a schematic structural diagram of another form of the third embodiment of the present invention;

FIG. 8 is a schematic diagram of an internal structure of a fourth embodiment according to the present invention;

FIG. 9 is a schematic diagram of an exterior structure of the fourth embodiment according to the present invention;

FIG. 10 is a schematic structural diagram of another form of the fourth embodiment of the present invention;

FIG. 11 is a schematic diagram of an internal structure of a fifth embodiment according to the present invention;

FIG. 12 is a schematic diagram of an exterior structure of the fifth embodiment according to the present invention;

FIG. 13 is a schematic diagram of an internal structure of a sixth embodiment according to the present invention; and

FIG. 14 is a schematic diagram of an exterior structure of the sixth embodiment according to the present invention.

### DETAILED DESCRIPTION OF EMBODIMENTS

The present invention is further described below in detail with reference to the accompanying drawings.

Embodiment 1: This embodiment takes a “joystick potentiometer” as an example. An adjustable telescopic rod 5 is in the form of “threaded rod”.

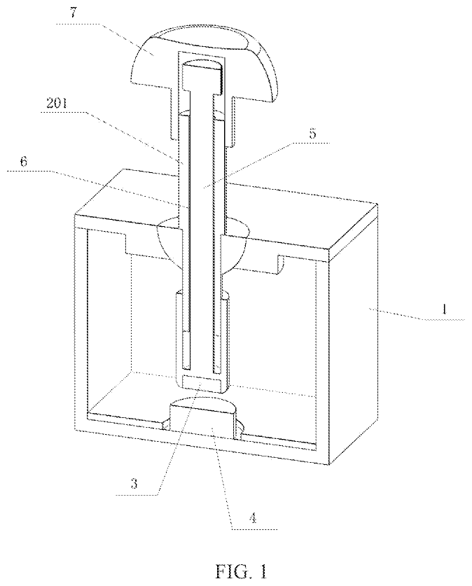

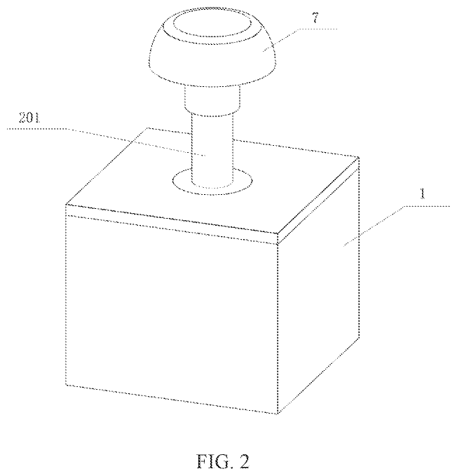

As shown in FIG. 1 and FIG. 2, an electronic device signal input apparatus of this embodiment includes a housing 1 provided with an operating component. The signal input apparatus is a joystick potentiometer. The operating component is a joystick 201 of the joystick potentiometer. The joystick 201 can implement a swinging action through a universal hemisphere (as shown in FIG. 1) or another swing arm mechanism (not shown in the figure). A first magnet 3 is fixed at an inner end of the joystick 201, a second magnet 4 is fixed on the housing 1 at a position opposite the first magnet 3, and the first magnet 3 and the second magnet 4 attract each other. The joystick 201 is provided with an adjustable telescopic rod 5 that runs through both inner and outer ends of the joystick 201, and the first magnet 3 is fixed at an inner end of the adjustable telescopic rod 5. The adjustable telescopic rod 5 is a threaded rod. The joystick 201 is provided with an internally threaded through hole 6 that matches the threaded rod for telescopic adjustment. A rod cap 7 is mounted on an outer end of the joystick 201. The rod cap 7 is directly connected to the outer end of the joystick 201 (the rod cap 7 may be connected to the outer end of the joystick 201 with an interference fit, a thread fit, etc.), and is not in contact with the adjustable telescopic rod 5.

The working principle of the present invention is as follows: When the joystick 201 swings, returning is implemented through a magnetic attraction force between the first magnet 3 and the second magnet 4. In addition, with the rod cap 7 removed, a distance between the first magnet 3 and the second magnet 4 is adjusted by rotating the adjustable telescopic rod 5 (the threaded rod), so that hand resistance of the joystick 201 during swinging can be adjusted. The smaller the distance between the first magnet 3 and the second magnet 4, the greater the hand resistance, and conversely, the hand resistance is smaller.

Embodiment 2: This embodiment takes a “joystick potentiometer” as an example. An adjustable telescopic rod 5 is in the form of “polished rod”.

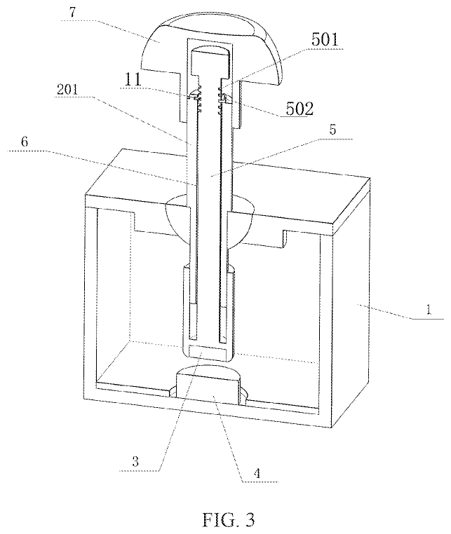

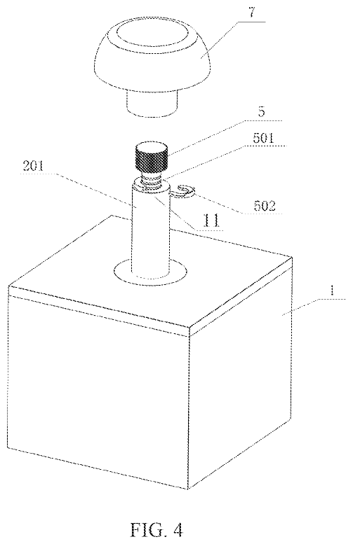

As shown in FIG. 3 and FIG. 4, an electronic device signal input apparatus of this embodiment includes a housing 1 provided with an operating component. The signal input apparatus is a joystick potentiometer. The operating component is a joystick 201 of the joystick potentiometer. The joystick 201 can implement a swinging action through a universal hemisphere (as shown in FIG. 3) or another swing arm mechanism (not shown in the figure). A first magnet 3 is fixed at an inner end of the joystick 201, a second magnet 4 is fixed on the housing 1 at a position opposite the first magnet 3, and the first magnet 3 and the second magnet 4 attract each other. The joystick 201 is provided with an adjustable telescopic rod 5 that runs through both inner and outer ends of the joystick 201, and the first magnet 3 is fixed at an inner end of the adjustable telescopic rod 5. The adjustable telescopic rod 5 is a polished rod provided with a number of adjustment positioning slots 501 or adjustment positioning holes (the adjustment positioning slots are selected in this embodiment). The joystick 201 is provided with a positioning clamp 502 or a positioning pin that matches the adjustment positioning slot 501 or the adjustment positioning hole (the positioning clamp is selected in this embodiment). The positioning clamp 502 or the positioning pin also clamps a slot 11 provided on a lifting slider 203 while clamping the telescopic rod. The joystick 201 is provided with a polished hole that matches the polished rod for telescopic adjustment. A rod cap 7 is mounted on an outer end of the joystick 201. The rod cap 7 is directly connected to the outer end of the joystick 201 (the rod cap 7 may be connected to the outer end of the joystick 201 with an interference fit, a thread fit, etc.), and is not in contact with the adjustable telescopic rod 5.

The working principle of the present invention is as follows: When the joystick 201 swings, returning is implemented through a magnetic attraction force between the first magnet 3 and the second magnet 4. In addition, with the rod cap 7 removed, a distance between the first magnet 3 and the second magnet 4 is adjusted by rotating the adjustable telescopic rod 5 (the polished rod), so that hand resistance of the joystick 201 during swinging can be adjusted. The smaller the distance between the first magnet 3 and the second magnet 4, the greater the hand resistance, and conversely, the hand resistance is smaller.

Embodiment 3: This embodiment takes a “rotary potentiometer” as an example. An adjustable telescopic rod 5 is in the form of “threaded rod”.

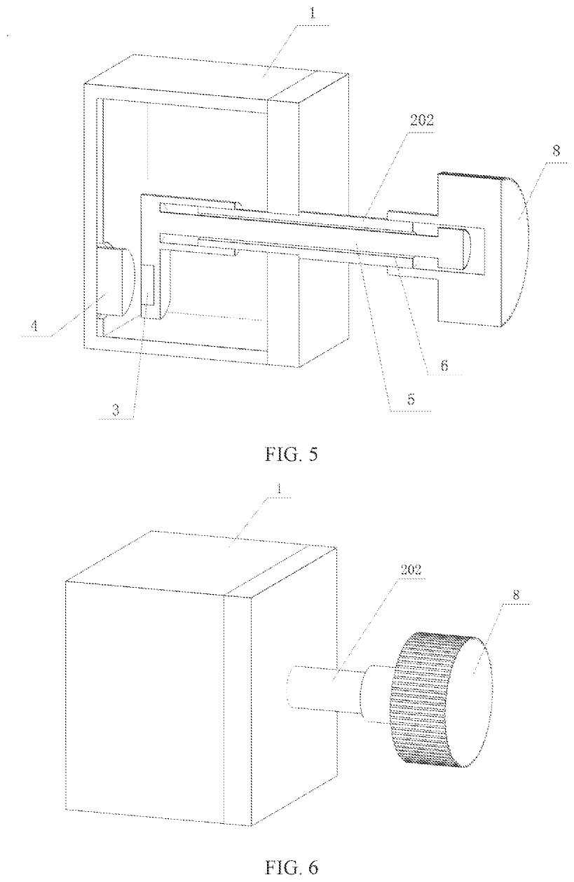

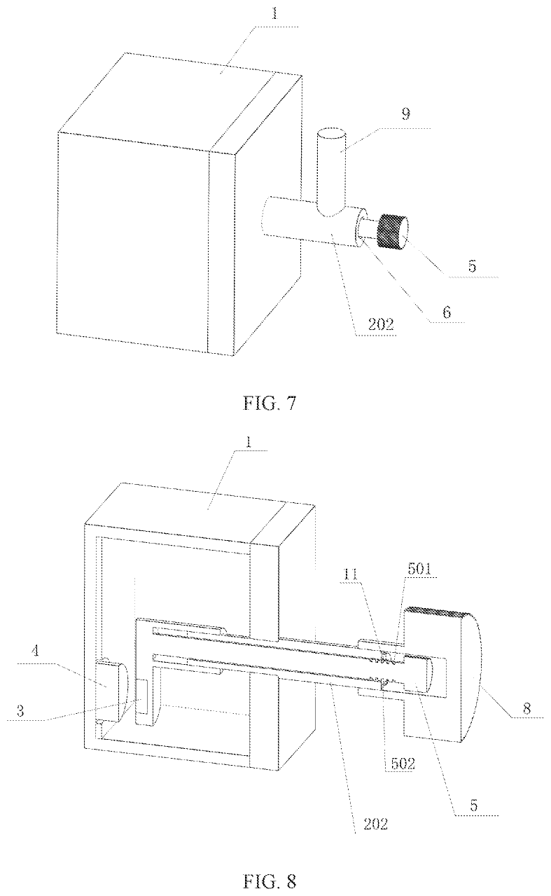

As shown in FIG. 5 and FIG. 6, an electronic device signal input apparatus of this embodiment includes a housing 1 provided with an operating component. The signal input apparatus is a rotary potentiometer. The operating component is a rotating shaft 202 of the rotary potentiometer. A first magnet 3 is fixed in a radial direction of an inner end of the rotating shaft 202, a second magnet 4 is fixed on the housing 1 at a position opposite the first magnet 3, and the first magnet 3 and the second magnet 4 attract each other. The rotating shaft 202 is provided with an adjustable telescopic rod 5 that runs through both inner and outer ends of the rotating shaft 202, and the first magnet 3 is fixed at an inner end of the adjustable telescopic rod 5. The adjustable telescopic rod 5 is a threaded rod. The rotating shaft 202 is provided with an internally threaded through hole 6 that matches the threaded rod for telescopic adjustment. A knob 8 is mounted at an outer end of the rotating shaft 202, or a rotary driving end 9 extends from the radial direction thereof (as shown in FIG. 7). In the case of the knob 8, the knob 8 is directly connected to the outer end of the rotating shaft 202 (the knob 8 may be connected to the outer end of the rotating shaft 202 with an interference fit, a thread fit, etc.), and is not in contact with the adjustable telescopic rod 5.

The working principle of the present invention is as follows: When the rotating shaft 202 rotates, returning is implemented through a magnetic attraction force between the first magnet 3 and the second magnet 4. In addition, with the knob 8 removed, a distance between the first magnet 3 and the second magnet 4 is adjusted by rotating the adjustable telescopic rod 5 (the threaded rod), so that hand resistance of the rotating shaft 202 during rotation can be adjusted. The smaller the distance between the first magnet 3 and the second magnet 4, the greater the hand resistance, and conversely, the hand resistance is smaller.

Embodiment 4: This embodiment takes a “rotary potentiometer” as an example. An adjustable telescopic rod 5 is in the form of “polished rod”.

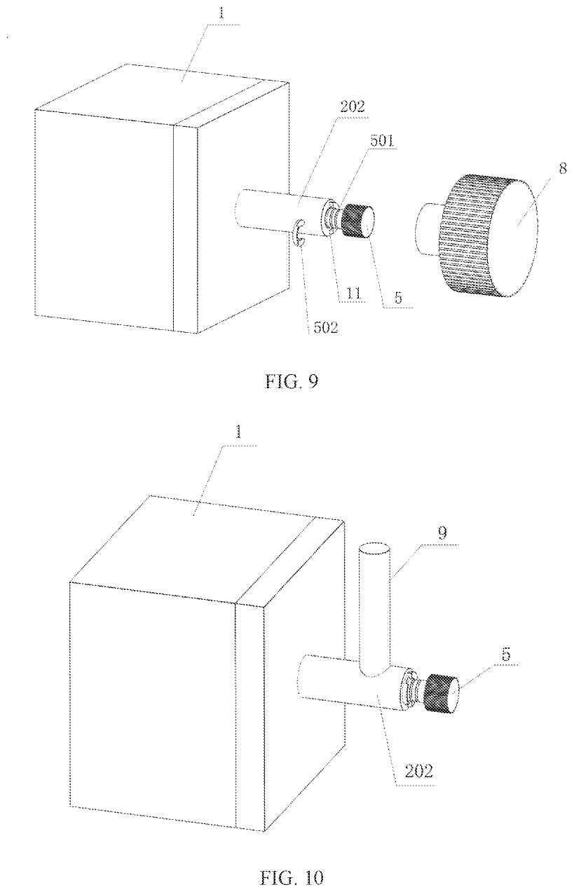

As shown in FIG. 8 and FIG. 9, an electronic device signal input apparatus of this embodiment includes a housing 1 provided with an operating component. The signal input apparatus is a rotary potentiometer. The operating component is a rotating shaft 202 of the rotary potentiometer. A first magnet 3 is fixed in a radial direction of an inner end of the rotating shaft 202, a second magnet 4 is fixed on the housing 1 at a position opposite the first magnet 3, and the first magnet 3 and the second magnet 4 attract each other. The rotating shaft 202 is provided with an adjustable telescopic rod 5 that runs through both inner and outer ends of the rotating shaft 202, and the first magnet 3 is fixed at an inner end of the adjustable telescopic rod 5. The adjustable telescopic rod 5 is a polished rod provided with a number of adjustment positioning slots 501 or adjustment positioning holes (the adjustment positioning slots are selected in this embodiment). The rotating shaft 202 is provided with a positioning clamp 502 or a positioning pin that matches the adjustment positioning slot 501 or the adjustment positioning hole (the positioning clamp is selected in this embodiment). The positioning clamp 502 or the positioning pin also clamps a slot 11 provided on a lifting slider 203 while clamping the telescopic rod. The rotating shaft 202 is provided with a polished hole that matches the polished rod for telescopic adjustment. A knob 8 is mounted at an outer end of the rotating shaft 202, or a rotary driving end 9 extends from the radial direction thereof (as shown in FIG. 10). In the case of the knob 8, the knob 8 is directly connected to the outer end of the rotating shaft 202 (the knob 8 may be connected to the outer end of the rotating shaft 202 with an interference fit, a thread fit, etc.), and is not in contact with the adjustable telescopic rod 5.

The working principle of the present invention is as follows: When the joystick 201 swings, returning is implemented through a magnetic attraction force between the first magnet 3 and the second magnet 4. In addition, with the knob 8 removed, a distance between the first magnet 3 and the second magnet 4 is adjusted by rotating the adjustable telescopic rod 5 (the polished rod), so that hand resistance of the rotating shaft 202 during rotation can be adjusted. The smaller the distance between the first magnet 3 and the second magnet 4, the greater the hand resistance, and conversely, the hand resistance is smaller.

Embodiment 5: This embodiment takes a “button” as an example. An adjustable telescopic rod 5 is in the form of “threaded rod”.

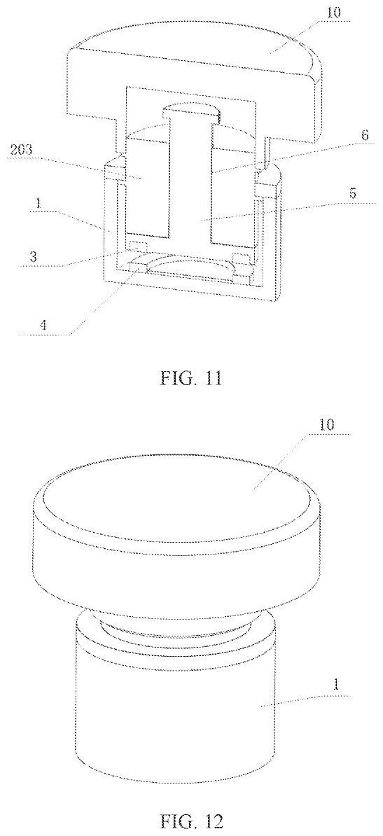

As shown in FIG. 11 and FIG. 12, an electronic device signal input apparatus of this embodiment includes a housing 1 provided with an operating component. The signal input apparatus is a button. The operating component is a lifting slider 203 of the button. A first magnet 3 is fixed at an inner end of the lifting slider 203, a second magnet 4 is fixed on the housing 1 at a position opposite the first magnet 3, and the first magnet 3 and the second magnet 4 repel each other. In addition, the first magnet 3 and the second magnet 4 are preferably in the shape of a circular ring, with a hollow part in the middle configured for arrangement of functional elements of the button. The lifting slider 203 is provided with an adjustable telescopic rod 5 that runs through both inner and outer ends of the lifting slider 203, and the first magnet 3 is fixed at an inner end of the adjustable telescopic rod 5. The adjustable telescopic rod 5 is a threaded rod. The lifting slider 203 is provided with an internally threaded through hole 6 that matches the threaded rod for telescopic adjustment. A button cap 10 is mounted on an outer end of the lifting slider 203. The button cap 10 is directly connected to the outer end of the lifting slider 203 (the button cap 10 may be connected to the outer end of the lifting slider 203 with an interference fit, a thread fit, etc.), and is not in contact with the adjustable telescopic rod 5.

The working principle of the present invention is as follows: When the lifting slider 203 goes up and down, returning is implemented through a magnetic repulsive force between the first magnet 3 and the second magnet 4. In addition, with the button cap 10 removed, a distance between the first magnet 3 and the second magnet 4 is adjusted by rotating the adjustable telescopic rod 5 (the threaded rod), so that initial hand resistance of the button during press-down can be adjusted. The smaller the distance between the first magnet 3 and the second magnet 4, the greater the initial hand resistance during press-down, and conversely, the initial hand resistance during press-down is smaller.

Embodiment 6: This embodiment takes a “button” as an example. An adjustable telescopic rod 5 is in the form of “polished rod”.

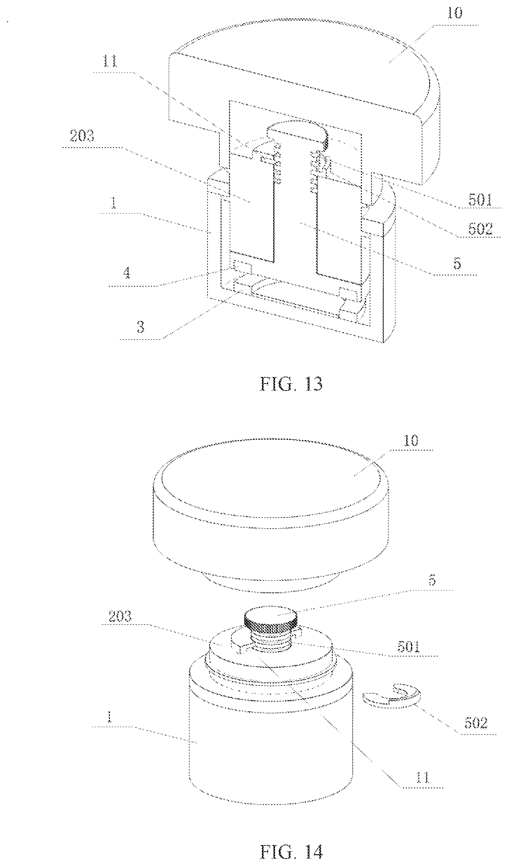

As shown in FIG. 13 and FIG. 14, an electronic device signal input apparatus of this embodiment includes a housing 1 provided with an operating component. The signal input apparatus is a button. The operating component is a lifting slider 203 of the button. A first magnet 3 is fixed at an inner end of the lifting slider 203, a second magnet 4 is fixed on the housing 1 at a position opposite the first magnet 3, and the first magnet 3 and the second magnet 4 repel each other. The lifting slider 203 is provided with an adjustable telescopic rod 5 that runs through both inner and outer ends of the lifting slider 203, and the first magnet 3 is fixed at an inner end of the adjustable telescopic rod 5. The adjustable telescopic rod 5 is a polished rod provided with a number of adjustment positioning slots 501 or adjustment positioning holes (the adjustment positioning slots are selected in this embodiment). The lifting slider 203 is provided with a positioning clamp 502 or a positioning pin that matches the adjustment positioning slot 501 or the adjustment positioning hole (the positioning clamp is selected in this embodiment). The positioning clamp 502 or the positioning pin also clamps a slot 11 provided on a lifting slider 203 while clamping the telescopic rod. The lifting slider 203 is provided with a polished hole that matches the polished rod for telescopic adjustment. A button cap 10 is mounted on an outer end of the lifting slider 203. The button cap 10 is directly connected to the outer end of the lifting slider 203 (the button cap 10 may be connected to the outer end of the lifting slider 203 with an interference fit, a thread fit, etc.), and is not in contact with the adjustable telescopic rod 5.

The working principle of the present invention is as follows: When the lifting slider 203 goes up and down, returning is implemented through a magnetic repulsive force between the first magnet 3 and the second magnet 4. In addition, with the button cap 10 removed, a distance between the first magnet 3 and the second magnet 4 is adjusted by rotating the adjustable telescopic rod 5 (the polished rod), so that initial hand resistance of the button during press-down can be adjusted. The smaller the distance between the first magnet 3 and the second magnet 4, the greater the initial hand resistance during press-down, and conversely, the initial hand resistance during press-down is smaller.

The foregoing description is merely illustrative of the embodiments of the present invention, and is not intended to limit the patent scope of the present invention. Any transformations of equivalent structures or equivalent procedures made using the contents of the specification and the accompanying drawings of the present invention, or any direct or indirect applications thereof in other related technical fields shall equally fall within the scope of patent protection of the present invention.

What is claimed is:

1. An electronic device signal input apparatus, comprising a housing provided with an operating component, wherein a first magnet is fixed at an inner end of the operating component, a second magnet is fixed on the housing at a position opposite the first magnet, and the first magnet and the second magnet attract each other.

2. The electronic device signal input apparatus according to claim 1, wherein the operating component is provided with an adjustable telescopic rod that runs through both inner and outer ends of the operating component, and the first magnet is fixed at an inner end of the adjustable telescopic rod.

3. The electronic device signal input apparatus according to claim 1, wherein the adjustable telescopic rod is a threaded rod, and the operating component is provided with an internally threaded through hole that matches the threaded rod for telescopic adjustment.

4. The electronic device signal input apparatus according to claim 1, wherein the adjustable telescopic rod is a polished rod provided with a number of adjustment positioning slots or adjustment positioning holes, and the operating component is provided with a polished hole that matches the polished rod for telescopic adjustment.

5. The electronic device signal input apparatus according to claim 1, wherein the signal input apparatus is a joystick potentiometer, and the operating component is a joystick of the joystick potentiometer.

6. The electronic device signal input apparatus according to claim 2, wherein the signal input apparatus is a joystick potentiometer, and the operating component is a joystick of the joystick potentiometer.

7. The electronic device signal input apparatus according to claim 3, wherein the signal input apparatus is a joystick potentiometer, and the operating component is a joystick of the joystick potentiometer.

8. The electronic device signal input apparatus according to claim 4, wherein the signal input apparatus is a joystick potentiometer, and the operating component is a joystick of the joystick potentiometer.

9. The electronic device signal input apparatus according to claim 1, wherein the signal input apparatus is a rotary potentiometer, and the operating component is a rotating shaft of the rotary potentiometer.

10. The electronic device signal input apparatus according to claim 2, wherein the signal input apparatus is a rotary potentiometer, and the operating component is a rotating shaft of the rotary potentiometer.

11. The electronic device signal input apparatus according to claim 3, wherein the signal input apparatus is a rotary potentiometer, and the operating component is a rotating shaft of the rotary potentiometer.

12. The electronic device signal input apparatus according to claim 4, wherein the signal input apparatus is a rotary potentiometer, and the operating component is a rotating shaft of the rotary potentiometer.

13. An electronic device signal input apparatus, comprising a housing provided with an operating component, wherein a first magnet is fixed at an inner end of the operating component, a second magnet is fixed on the housing at a position opposite the first magnet, and the first magnet and the second magnet repel each other.

14. The electronic device signal input apparatus according to claim 13, wherein the signal input apparatus is a button, and the operating component is a lifting slider of the button.
